(19) United States
(12) Patent Application Publication
(10) Pub. No.: US 2011/0011972 A1
(43) Pub. Date: Jan. 20, 2011

(54) PRIMARY STRUCTURE OF A CONNECTING STRUT

(75) Inventor: Jean-Bernard Vache, Le Havre (FR)

Correspondence Address: CANTOR COLBURN LLP, 20 Church Street, 22nd Floor, Hartford, CT, 06103, US

(73) Assignee: AIRCELLE, Gonfreville L'orcher (FR)

(21) Appl. No.: 12/934,670

(22) PCT Filed: Feb. 20, 2009
(86) PCT No.: PCT/FR09/00189

§ 371 Date: Sep. 27, 2010

(30) Foreign Application Priority Data
Mar. 28, 2008 (FR) 08/01718

(51) Int. Cl. B64D 27/26

(52) U.S. Cl. 244/54

(57) ABSTRACT

The invention relates to an effort recovery structure (101) of a connecting strut for attaching a turboreactor to the wing system of an aircraft. Said structure comprises a first lateral block (102) and a second lateral block (103) to be attached to the wing system of the aircraft, and a spigot fastener to be attached to the turboreactor, said lateral blocks (102, 103) surrounding an essentially long central plate (104) following the main axis (105) of the structure (101). The central plate (104) is connected to the spigot fastener and is produced from a metal or an alloy that can resist a temperature of at least 1000° C. over a period of at least 15 minutes, such as to recover the static and dynamic efforts generated by the turboreactor according to the main axis (105). The invention also relates to a connecting strut for attaching a turboreactor to a wing system of an aircraft, comprising such a primary structure (101).

### TECHNICAL FIELD

The invention relates to an effort recovery structure of a connecting strut for attaching a turboreactor to a wing system of an aircraft.

### BACKGROUND

The purpose of a connecting strut is to ensure connection between a turboreactor and the wing system of an aircraft. Consequently, on a first end, the connecting strut is attached to the turboreactor by a rear attachment and a front attachment in the shape of a pyramid. On a second end, the connecting strut is attached to a wing system of the aircraft by a front attachment, a rear attachment and an upper attachment, called “spigot”.

The connecting strut is, in a known manner, designed for transmission to the wing system of static and dynamic efforts generated by the turboreactor, such as weight or thrust.

To transmit these efforts, the connecting strut comprises a rigid structure, called “effort recovery structure” or “primary structure” and a plurality of structures, called “secondary”, complementary to the primary structure.

The secondary structures ensure segregation and the retention of the systems, such as hydraulics, electrical, fuel routing, packaging systems. These secondary structures support, moreover, aerodynamic fairing elements in the shape of panels mounted on the secondary structures.

In a standard manner, the turboreactor is surrounded by a nacelle, which can comprise means for reverse thrust. The primary structure generally carries the cowls of the nacelle while the secondary structures carry the fan cowls of the turboreactor.

The primary structure is rigid compared to the secondary structures to recover the static and dynamic efforts generated by the turboreactor. On the contrary, the secondary structures are not designed to recover such efforts.

Conventionally, the primary structure 1 has the shape of a “box” formed by two metal lateral panels 2 and 3 (see FIG. 1), by an upper metal spar 5 and by a lower metal spar 6. The spars 5 and 6 are configured to connect respectively the upper and the lower portions of the lateral panels 2 and 3. Longitudinal 7 and transverse 8 stiffeners located on each lateral panel 2 and 3 provide the rigidity of the primary structure 1.

Inside the box, a multitude of reinforcement frames 9 are arranged between the metal spars 5 and 6 and the lateral panels 2 and 3.

At one end of the primary structure 1, a pyramid 10 is mounted on the extremal reinforcing frame 9. The pyramid 10 has an attachment for attaching the primary structure 1 to the turboreactor.

However, this type of primary structure has the drawback of complex and lengthy implementation and installation on a wing system of an aircraft.

To simplify implementation and installation of the primary structures of a connecting strut, in patent application FR 2 889 505 is proposed a primary structure 11 (see FIG. 2) having two lateral walls 12 and 13 in composite material, an upper spar 15 and a lower spar 16. A pyramid 20 located at one end of the primary structure 11 comprises an attachment designed for attaching said structure 11 to the turboreactor. This type of primary structure 11 no longer has longitudinal or transverse stiffener or reinforcing frame.

Nevertheless, this type of primary structure has the drawback of not ensuring satisfactory safety in case of fire of the turboreactor. In fact, in case of fire of the turboreactor, it is important that the primary structure supports the turboreactor during a period defined by EU and/or American regulations, typically in the order of 15 minutes according to American standard FAA-AC 25-865. Now, the type of primary structure described in patent application FR 2 889 505 tends to break before expiry of this period. In addition, this type of primary structure has the drawback of not recovering the efforts about the main axis, namely along the length of the primary structure. The upper attachment (or “spigot”) to the wing system is inserted into two openings 17 mounted projecting on the lateral walls 12 and 13. Such a configuration tends to weaken the connecting strut.

### BRIEF SUMMARY

The invention provides a primary structure of a connecting strut by increasing the duration support of the turboreactor in case of fire.

The invention further provides a primary structure of the connecting strut more resistant to the efforts and easier to produce and mount on a wing system of an aircraft.

To this end, according to a first aspect, the invention relates to a primary structure of a connecting strut for attaching a turboreactor to a wing system of an aircraft, characterised in that it comprises a first lateral block and a second lateral block, said lateral blocks surrounding a central plate produced in a material that can resist a temperature of at least 1,000° C. over a period of at least equal to 15 minutes.

The invention relates to an effort recovery structure of a connecting strut for attaching a turboreactor to a wing system of an aircraft, characterised in that it comprises a first lateral block and a second lateral block, designed to be attached to the wing system of the aircraft, a spigot fastener for being attached to the turboreactor, said lateral blocks surrounding a central plate of a substantially long shape along the main axis of said structure and said plate being connected to said spigot fastener, the central plate being produced in a metal or an alloy that can resist a temperature of at least 1,000° C. over a period of at least equal to 15 minutes, such as to recover the static and dynamic efforts generated by the turboreactor according to the main axis.

By “material that can resist a temperature of at least 1,000° C. over a period of at least equal to 15 minutes”, here it is meant a material, which when subjected to a temperature greater than or equal to 1,000° C. retains sufficient mechanical stiffness to support the turboreactor over a period of at least equal to 15 minutes.

The primary structure according to the invention has an easier production and a simpler assembly than that of the prior art. In fact, the structure of the invention comprises fewer constituting elements than those of the prior art: two lateral blocks and a central plate.

The low number of constituting elements also allows having a weight gain of the structure of the invention. The presence of the central plate provides improving the resistance of the connecting strut. In fact, the central plate recovers the various static and dynamic efforts generated by the turboreactor along the main axis of the structure of the invention, namely the principal axis of the connecting strut.

Moreover, in case of fire, regardless of the material used to produce the lateral blocks, the central plate retains the turboreactor by being, for example, connected to the front pyramid shaped attachment connected to the turboreactor. In fact, the central plate is produced from a material that can resist a temperature of at least equal to 1,000° C., in particular of at least equal to 1,200° C., indeed even of at least equal to 1,400° C. over a period of at least equal to 15 minutes, in particular to 20 minutes, indeed even 1 hour. Consequently, the turboreactor is supported by the structure of the invention for a longer period than in the case of patent application FR 2 889 505.

Therefore, the structure of the invention meets the European JAA (Joint Aviation Authorities) and U.S. FAA (Federal Aviation Administration) regulations on the subject of fire safety and in particular, the minimum period for supporting the turboreactor before breaking.

According to other characteristics of the invention, the structure of the invention comprises one or more of the following optional characteristics considered individually or according to all possible combinations:
the material of the central plate is a metal or an alloy, in particular an alloy comprising nickel;
each lateral block comprises a lateral wall extending in an L shaped upper element complying to be substantially opposite with respect to the upper element of the other lateral block;
the structure of the invention has a substantially trapezoidal transverse cross-section defining a bottom base and an upper base thereby retaining at best the central plate and limiting the number of pieces;
the width of the bottom base is smaller than the width of the upper base thereby limiting the quantity of material of the lateral blocks;
the first block and the second block are produced in a composite material thereby allowing both an easier moulding production of the primary structure, for example of the RTM type, and a mass gain for the connecting strut;
the central plate has at least two corrugated sheets thereby increasing the inertia of the central plate;
the central plate has a thickness comprised between 15 mm and 30 mm thereby providing a good compromise between optimum support of the turboreactor in case of fire thereof and a not too significant mass;
a first metal cap and a second metal cap substantially ribbed are mounted respectively on the first lateral block and the second lateral block for connecting the primary structure to the wing system of the aircraft thereby making easier the assembly and disassembly of the powertrain and also to support heavy loads such as a turboreactor;
the first metal cap and the second metal cap are metallic thereby ensuring retention of the turboreactor even in case of fire thereof.

According to a second aspect, the invention also relates to a connecting strut for attaching a turboreactor to a wing system of an aircraft comprising a primary structure according to the invention.

### BRIEF DESCRIPTION OF THE DRAWINGS

The invention will be further understood upon reading of the non-exhaustive description which follows, with reference to the Figures annexed hereby.

FIG. 1 is an exploded perspective view of a primary structure as used by the prior art;

FIG. 2 is an exploded perspective view of a primary structure according to patent application FR 2 889 505;

FIG. 3 is a perspective view of an embodiment of a structure according to the invention;

FIG. 4 is an exploded perspective view of the embodiment of FIG. 1;

FIG. 5 is a partial top view of an embodiment of the invention;

FIG. 6 is an offset enlarged view of area VI of the embodiment of FIG. 5.

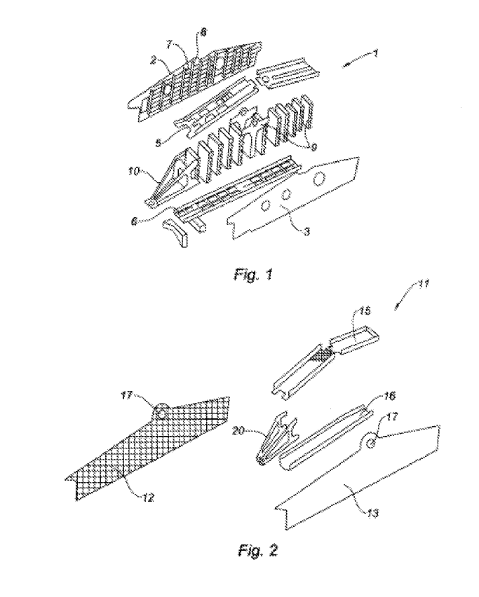

### DETAILED DESCRIPTION

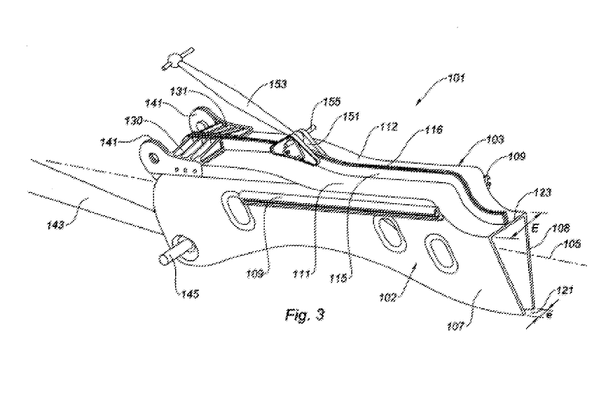

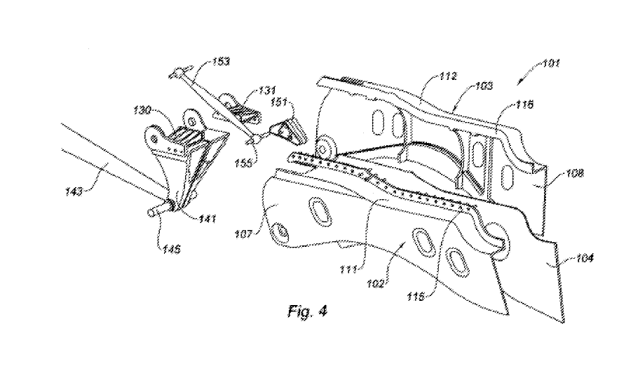

According to the embodiment shown in FIGS. 3 and 4, the structure according to the invention 101 comprises a first lateral block 102 and a second lateral block 103 surrounding a central plate 104.

The structure of the invention 101 is designed to attach a turboreactor (not shown) to a wing system of an aircraft (not shown). The connecting strut (not shown) comprising the structure of the invention 101 can support any type of nacelles surrounding the turboreactor, in particular structuring nacelles comprising one or more supports of integrated grid(s) to the connecting strut.

Advantageously, the structure according to the invention 101 has a number of components smaller than those of the prior art. Thus, a primary structure is obtained with a mass gain resulting from the absence of a multitude of parts, in particular of the reinforcement or stiffener type.

Moreover, assembly of these components is easy since it is simply only necessary to join the first lateral block 102 and the second lateral block 103 to form the structure according to the invention 101. Unlike the prior art, it is no longer necessary to connect small parts among thereof or with larger elements to form a primary structure. Thus, the assembly of the structure 101 according to the invention results simplified.

The structure of the invention has a substantially long shape, namely that the length following a main axis 105 is greater than the width along an axis perpendicular to the main axis 105. The main axis 105 is generally the same as that of the connecting strut.

Preferably, each lateral block 102 (103) comprises a lateral wall 107 (108) extending in an L shaped upper element 111 (112), complying to be substantially opposite with respect to the upper element 112 (111) of the other lateral block 102 (103).

Each lateral wall 107 and 108 may comprise means for attaching secondary structures to form the connecting strut. By way of example, the means are rails 109 mounted on walls 107, 108.

The upper element 111, 112 may comprise, as shown in FIGS. 3 and 4, a lip 115, 116. The lips 115 and 116 of the upper elements are designed to come alongside and to be fixed together by any means known to the person skilled in the art, in particular by bolts.

Preferably, the structure of the invention 101 has a transverse section, that is to say perpendicular to the main axis 105, substantially trapezoidal defining a lower base 121 and an upper base 123. By “trapezoidal”, it is here meant a section having a lower base 121 and an upper base 123 substantially parallel to each other. Such a geometrical form allows retaining at best the central plate 104 between the lateral blocks 102 and 103 and, in addition, to run the cables and pipes required for the operation of the nacelle and the turboreactor (not shown). According to a preferred embodiment, the width e of the lower base 121 is smaller than that E of the upper base 123, thereby limiting the amount of materials needed to produce the lateral blocks 102 and 103. Typically, the width e of the lower base 121 is comprised between 90 mm and 140 mm, in particular between 100 mm and 120 mm. Similarly, the width E of the upper base 123 is typically comprised between 260 mm and 340 mm, in particular between 280 mm and 320 mm.

The first lateral block 102 and the second lateral block 103 are preferably produced in a composite material, such as bismaleimide resin (BMI), the epoxy resin resistant to temperatures above 200° C., in particular equal to about 280° C., such as PMR15® or in carbon. An advantage of using a composite material is to facilitate the production of the lateral blocks 102 and 103 and to reduce their mass.

Production of the lateral blocks 102 and 103 can be achieved by draping or an RTM (“Resin Transfer Moulding”) method.

The “draping” method concerns placing into a mould all fibres impregnated with resin such as to form the desired preform and then in applying substantially a vacuum to compact the assembly. Then, heating is applied to melt the resin contained in the fibres, thereby making the connection among the fibres.

The RTM method concerns spreading resin into the fibres of a preform provided with interlayer fibrous layers. More specifically, the assembly comprising the fibrous preforms is placed within a closed mould the shape of which generally corresponds to that of the mechanical part to be achieved and a resin is injecting into the mould. Hence, the resin penetrates the assembly formed by the fibrous preforms.

The RTM method is advantageous to the extent that it is not expensive, simple to implement and offering a material of good mechanical strength.

In addition, the part resulting from the RTM method requires only a minimal finishing. In fact, the parts out of the moulds are in finished dimensions, that is to say they do not need to be machined. Moreover, the RTM method allows a repeatability of the geometry of the parts.

The lateral blocks 102 and 103 have a substantially long shape. The length of the lateral blocks 102 and 103 along the main axis 105 is in particular comprised between 2,050 mm and 2,600 mm, indeed even between 2,200 mm and 2,400 mm.

The central plate 104 has also a substantially long shape with a length along the main axis 105 equal to, or better still lower than, the length of the lateral blocks 102 and 103. The thickness of the central plate 104 along an axis substantially perpendicular to the main axis 105 is typically lower than the length of the latter. The thickness of the central plate 104 is generally comprised between 15 mm and 20 mm, in particular between 15 mm and 25 mm, preferably between 15 mm and 30 mm, thereby providing a good compromise between an optimum support of the turboreactor in case of fire thereof and a not too significant mass of the structure of the invention 101.

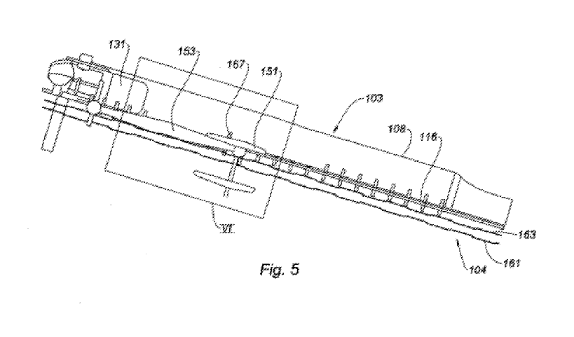

According to a preferred embodiment shown in FIG. 5, the central plate 104 has two corrugated sheets 161 and 163. Typically, the two sheets 161 and 163 are obtained by dimpling and welding. In general, the central plate 104 may comprise more than two corrugated sheets. During assembly of the structure of the invention 101, the corrugated sheets 161 and 162 are fixed by any means known to the person skilled in the art so that air cavities are defined at the contact areas. Consequently, the thermal inertia of the plate 104 is improved. In addition, the presence of the corrugated sheets 161 and 163 can advantageously limit the quantity of material required for the formation of the central plate 104 while retaining such sufficient rigidity as to support the turboreactor in case of fire.

The presence of the central plate 104 provides obtaining a structure of the invention 101 more resistant to static and dynamic efforts. In fact, the central plate 104 recovers the static and dynamic efforts generated by the turboreactor (not shown) along the main axis 105 of the structure according to the invention 101.

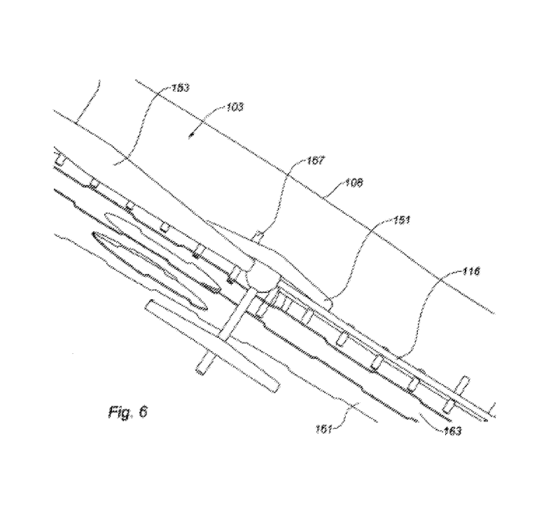

The central plate 104 is typically connected to a spigot fastener (not shown) made of metal or of any other suitable material known to the person skilled in the art. The spigot fastener, generally in the shape of a pyramid, is for being attached to the turboreactor. In addition, the central plate 104 is attached by any means known to the person skilled in the art, in particular by rivets 167, to a metal cap 151 connecting the structure the invention 101 to the wing system of the aircraft (see FIG. 6). Thus, in case of fire where temperatures are at least equal to 1,000° C., whatsoever the nature of the material used to produce the lateral blocks 102 and 103, the central plate 104 provides support to the turboreactor during a period equal to at least 15 minutes, in particular more than 30 minutes, indeed even more than 1 hour. The turboreactor is therefore retained during a period of at least equal to that set by the European JAA and U.S. FAA Standard, which is the period required for carrying out any possible emergency manoeuvre.

The central plate 104 is preferably made of a metallic material or of an alloy, preferably an alloy containing nickel. An alloy containing nickel is, for example Inconel®. More specifically, Inconel® is an alloy comprising mainly nickel, but also other metals such as chromium, magnesium, iron and titanium. It can be cited Inco625®, steel or even still any other alloy containing niobium.

In the case where the lateral blocks 102 and 103 are in carbon or composite material, these form a thermal shield around the central plate 104 due to the low thermal conductivity of carbon and the composite material.

According to a preferred embodiment, a first metal cap 130 and a second metal cap 131, substantially ribbed, are mounted respectively on the first lateral block 102 and the second lateral block 103 to connect the structure of the invention 101 to a wing system of the aircraft, not shown.

The presence of such metal caps 130 and 131 facilitates assembly and disassembly of the powertrain during maintenance interventions.

Preferably, the first metal cap 130 and the second metal cap 131 are made of metal thereby ensuring heavy loads such as retaining the turboreactor even in case of fire thereto.

In addition, the first and the second metal caps 130 and 131 have an easier machining of the parts.

The first and the second metal caps 130 and 131 are configured to receive a movable pivoting axis of a spigot fastener connecting the structure of the invention and the wing system of the aircraft.

The first and the second metal caps are mounted on a detachable support element 141 with respect to the structure of the invention 101. The support element receives a spigot fastener 143 which connects the structure of the invention 101 and the wing system of the aircraft (not shown). The spigot fastener 143 is movable about an axis 145 substantially perpendicular to the main axis 105.

Moreover, a metal cap 151 is mounted on the upper elements 111 and 112 for receiving a spigot fastener 153 also connecting the structure of the invention 101 and the wing system of the aircraft, but in an area separate than that which is designed to be the spigot fastener 143. The spigot fastener 153 is also movable pivoting about an axis 155 substantially parallel to the axis 145.

The metal cap 151, as shown in FIG. 6, is attached to the plate 104, here in the shape of two corrugated sheets 161 and 163 by any means known to the person skilled in the art, in particular by a rivet 167 or by a bolt.

1. Effort recovery structure of a connecting strut for attaching a turboreactor to a wing system of an aircraft, comprising:
a first lateral block and a second lateral block, to be attached to the wing system of the aircraft,
a spigot fastener to be attached to the turboreactor,
said lateral blocks surrounding an essentially long shaped central plate following a main axis of said structure and said plate being connected to said spigot fastener, the central plate being produced from a metal or any alloy that can resist a temperature of at least 1,000° C. over a period of at least 15 minutes, such as to recover static and dynamic efforts generated by the turboreactor according to the main axis.

2. Structure according to claim 1 wherein the central plate is composed of a metal or an alloy.

3. Structure according to claim 2 wherein the material is an alloy comprising nickel.

4. Structure according to claim 1, wherein each lateral block comprises a lateral wall extending in an L shaped upper element, complying to be substantially opposite with respect to the upper element of the other lateral block.

5. Structure according to claim 1, further comprising a substantially trapezoidal cross-section defining a lower base and an upper base.

6. Structure according to claim 5 wherein a width of the lower base is smaller than a width of the upper base.

7. Structure according to claim 1 wherein the first block and the second block are produced in a composite material.

8. Structure according to claim 1 wherein the central plate comprises at least two corrugated sheets.

9. Structure according to claim 1, wherein the central plate has a thickness comprised between 15 mm and 30 mm.

10. Structure according to claim 1 wherein a first metal cap and a second metal cap substantially ribbed are mounted respectively on the first lateral block and the second lateral block for connecting the primary structure to the wing system of the aircraft.

11. Structure according to claim 10 wherein the first metal cap and the second metal cap are metallic.

12. Connecting strut for attaching a turboreactor to a wing system of an aircraft comprising an effort recovery structure according to claim 1.
